(19) United States
(12) Patent Application Publication
(10) Pub. No.: US 2020/0190873 A1
(43) Pub. Date: Jun. 18, 2020

(54) Tailgate Latch Assembly for Vehicle

(71) Applicants: Hyundai Motor Company, Seoul (KR); Kia Motors Corporation, Seoul (KR)

(72) Inventor: Ki-Hyun Cho, Hwaseong-si (KR)

(21) Appl. No.: 16/701,438

(22) Filed: Dec. 3, 2019

(30) Foreign Application Priority Data
Dec. 17, 2018 (KR) 10-2018-0163537

(51) Int. Cl. E05B 85/26; B60J 5/10; E05B 81/06; E05B 81/30; E05B 83/16; E05B 85/24; F16H 1/16

(52) U.S. Cl. CPC E05B 85/26; B60J 5/102; E05B 81/06; E05B 81/30; E05Y 2201/704; E05B 85/243; F16H 1/16; E05Y 2900/546; E05Y 2201/702; E05B 83/16

(57) ABSTRACT

A tailgate latch assembly is provided for a vehicle. The tailgate latch assembly restrains a striker formed in a tailgate which is opened reward of a vehicle or release the striker from restraint. The tailgate latch assembly comprises a claw that is supported resiliently in a direction of releasing restraint of the striker in a housing and rotated in a direction opposite to the direction of being supported resiliently when the striker enters. A pawl is supported resiliently in the housing and restrains or releases the claw. A wheel gear is rotated by a drive motor and releases restraint of the claw by rotating the pawl after pushing a contact part formed on one side of the pawl by an operation part formed on one side of the wheel gear.

### CROSS-REFERENCE TO RELATED APPLICATIONS

This application claims priority to Korean Patent Application No. 10-2018-0163537, filed on Dec. 17, 2018, which application is hereby incorporated herein by reference.

### TECHNICAL FIELD

Exemplary embodiments of the present disclosure relate to a tailgate latch assembly for a vehicle.

### BACKGROUND

Vehicles such as a sports utility vehicle (SUV) and a van are equipped with a tailgate which is opened or closed rearward of the vehicle.

In general, an upper end of the tailgate is hinged to a vehicle body of the vehicle and the tailgate is controlled to be opened or closed by restraining a lower end thereof or releasing the lower end from restraint.

FIGS. 1 to 3 show a tailgate latch assembly no for a vehicle according to the prior art.

Referring to FIG. 1, when a user operates an outside handle to open the tailgate in a state where the latch no is locked, electric power is supplied to a drive motor 112. When electric power is applied to the drive motor 112, a worm gear 113, a wheel gear 114 and the like which are coupled to the drive motor 112 are rotated.

As shown in FIG. 2, when the wheel gear 114 is rotated, an actuation protrusion 114a formed on one side of the wheel gear 114 hits an end of a pawl 115 whereby the pawl 115 is rotated. When the pawl 115 is rotated, a claw 116 whose rotation is restrained by the pawl 115 is rotated by a spring so that the claw 116 is primarily released (in other words, the claw is half locked) Then, while electric power is supplied to the drive motor 112, a wheel gear 114 is rotated to the maximum and the pawl 115 is restrained by the wheel gear 114 whereby movement of the pawl 115 to the opposite direction (direction in which the pawl restrains the claw) by a spring is obstructed so that the claw 116 is maintained in a state of having been fully released from restraint. In this state, a striker 121 is broken away from the claw 116 whereby restraint of the tailgate latch assembly no is released.

On the other hand, in the tailgate latch assembly no according to the prior art, there is a problem that since a distance from the center of the wheel gear 114 to a position where the pawl 115 is struck is constant and thus actuation force for releasing restraint of the claw 116 is constant, the striker 121 of FIG. 1 attached to a vehicle body pulls the claw 116 strongly when actual reaction force pushing the tailgate increases depending on assembly variation of the tailgate whereby restraint between the pawl 115 and the claw 116 is not released quickly.

Further, as shown in FIG. 3, the prior art is configured such that when the wheel gear 114 is rotated to the maximum, a contact protrusion 114b formed on the wheel gear 114 is caught by a stopper 111a formed in a housing in of FIG. 1 and thus rotation of the wheel gear is obstructed whereas when power supply to the drive motor 112 is cut off, the wheel gear is returned by a spring mounted to the wheel gear 114. In other words, since the contact protrusion 114b of the wheel gear strikes the stopper 111a repeatedly, there is a possibility that the stopper 111a is broken and thus malfunction occurs.

On the other hand, a switch 117 to be operated by the claw 116 is installed adjacent to the claw 116 to detect the position of the claw 116 such that a user is notified whether the tailgate latch assembly no is released from locking. In this case, if the claw 116 is not normally operated due to fixing or jamming of the claw 116 even though the pawl 115 is actuated by actuation of the motor 112, there is a possibility that a lock release state of the tailgate latch assembly no cannot be accurately detected.

### SUMMARY

Exemplary embodiments of the present disclosure relate to a tailgate latch assembly for restraining a tailgate which is opened or closed rearward of a vehicle or releasing restraint of the tailgate. Embodiments relate to a tailgate latch assembly for a vehicle with improved detection performance, which is adapted to promptly detect whether a tailgate is opened or not when the tailgate is opened.

Embodiments can solve problems associated with the prior art. For example, embodiments of the present disclosure provide a tailgate latch assembly for a vehicle, which is adapted such that amount of actuation is increased in the beginning of opening a tailgate and moving speed of a pawl is increased after a locked state is released so that lock release force for releasing the locked state and lock detection performance are improved.

Another embodiment of the present disclosure is to provide a tailgate latch assembly for a vehicle, which is adapted such that malfunction or failure of a tailgate is improved through a pushing manner rather than a striking manner having a high possibility of malfunction or failure and open detection performance is improved.

Other advantages of the present disclosure can be understood by the following description and become apparent with reference to the embodiments of the present disclosure. Also, it is obvious to those skilled in the art to which the present disclosure pertains that the objects and advantages of the present disclosure can be realized by the means as claimed and combinations thereof.

In accordance with one aspect of the present disclosure, a tailgate latch assembly is provided for a vehicle. The tailgate latch assembly restrains a striker formed in a tailgate which is opened reward of a vehicle or release the striker from restraint. The tailgate latch assembly comprises a claw that is supported resiliently in a direction of releasing restraint of the striker in a housing and rotated in a direction opposite to the direction of being supported resiliently when the striker enters. A pawl is supported resiliently in the housing and restrains or releases the claw. A wheel gear is rotated by a drive motor and releases restraint of the claw by rotating the pawl after pushing a contact part formed on one side of the pawl by an operation part formed on one side of the wheel gear wherein an outer side face of the operation part is formed in such a manner that distance from the center of the wheel gear to a contact point of the operation part varies as the wheel gear rotates.

The tailgate latch assembly is characterized in that the outer side face of the operation part is formed in such a manner that the distance from the center of the wheel gear to the contact point of the operation part increases as the wheel gear further rotates.

The tailgate latch assembly is characterized in that the outer side face of the operation part is formed in such a manner that an increase rate of the distance from the center of the wheel gear to the contact point of the operation part decreases as the wheel gear further rotates.

The tailgate latch assembly is characterized in that the outer side face of the operation part is formed into an involute curve with respect to the center of the wheel gear.

The vehicle door glass is characterized in that the operation part is formed only in a partial section of the wheel gear.

The tailgate latch assembly is characterized in that one side face of the wheel gear is formed with a stopper for stopping rotation of the pawl at the time when the pawl is separated from the claw and a bottom face of the pawl is formed with a catching ledge to be caught by the stopper wherein when the pawl is separated from the claw, the catching ledge is caught by the stopper whereby rotation of the pawl is stopped.

The tailgate latch assembly is characterized in that the catching ledge is formed to be caught by the stopper when the distance from the center of the wheel gear to the contact point of the operation part becomes a maximum.

The tailgate latch assembly is characterized in that the operation part and the stopper are formed at different distances from the surface of the wheel gear on one side face of the wheel gear.

The tailgate latch assembly is characterized in that a switch for detecting separation of the pawl from the claw is installed and the tailgate latch assembly further comprises a detection plate for operating the switch at the time when the pawl is separated from the claw.

The tailgate latch assembly is characterized in that the detection plate is operated by an end of the pawl.

According to the tailgate latch assembly for a vehicle with improved detection performance of the present disclosure having the configuration as described above, since the distance between the portion where the operation part of the wheel gear is in contact with the contact part of the pawl and the center of the wheel gear increases in the form of an involute curve as the wheel gear rotates, actuation force is high at the initial period whereas moving speed is increased at the latter period. As a result, the actuation force of the pawl is high and a turning radius of the pawl is also large at the initial time when the operation part of the wheel gear comes into contact with the contact part of the pawl so that the pawl can release the claw quickly. In addition, moving speed of the pawl is increased from the middle half so that actuation of the pawl to release the claw can be completed quickly.

As such, since the actuation force in the beginning of actuation of the pawl is high and opening operation is completed quickly and accurately, detection performance of the tailgate latch assembly is improved.

In addition, since the restraint release of the striker is detected in the pawl, error of detecting opening of a tailgate can be reduced. Moreover, since the operation part is formed into an involute curve, depressing operation of the switch can also be improved in terms of detection speed and reliability.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view showing a state in which a pawl restrains a claw in a tailgate latch assembly for a vehicle according to the prior art;

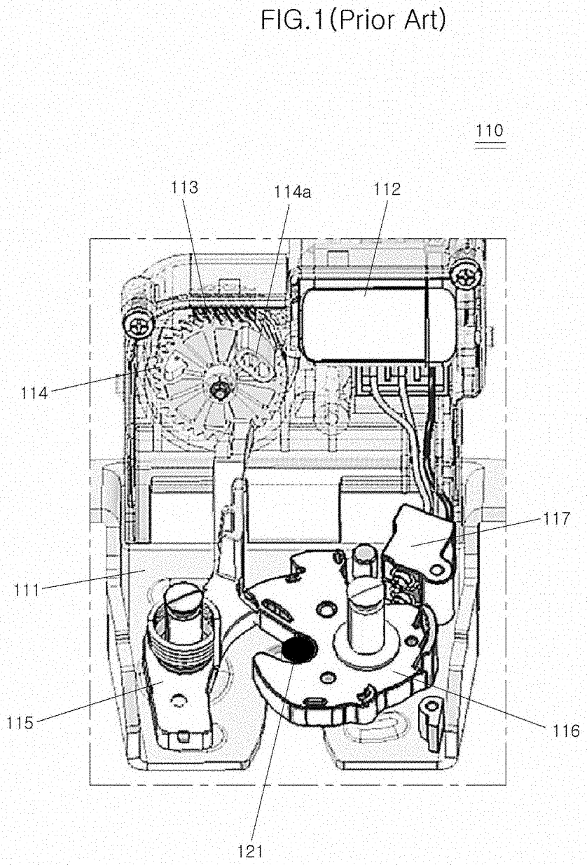

FIG. 2 is a perspective view showing a state in which a wheel gear rotates a pawl so as to release restraint of a claw in a tailgate latch assembly for a vehicle according to the prior art;

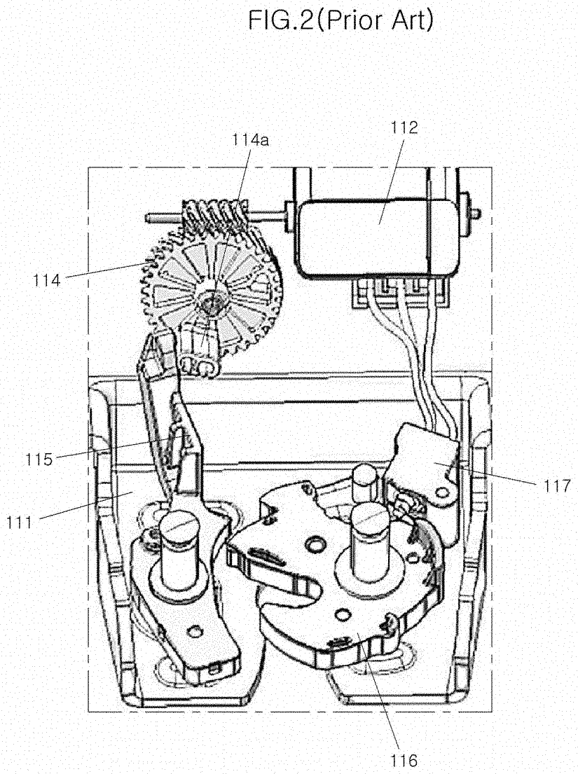

FIG. 3 is a partial enlarged perspective view showing an installation state of a wheel gear in a tailgate latch assembly for a vehicle according to the prior art;

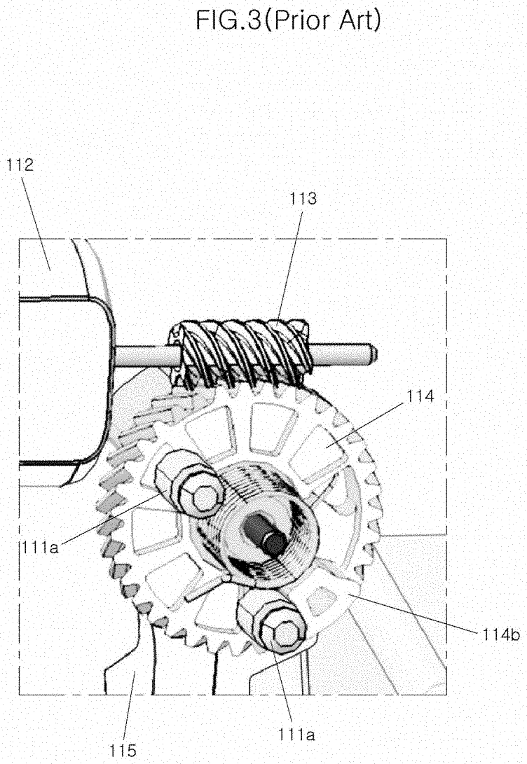

FIG. 4 is a perspective view showing a state in which a claw is restrained in a tailgate latch assembly for a vehicle with improved detection performance according to an embodiment of the present disclosure;

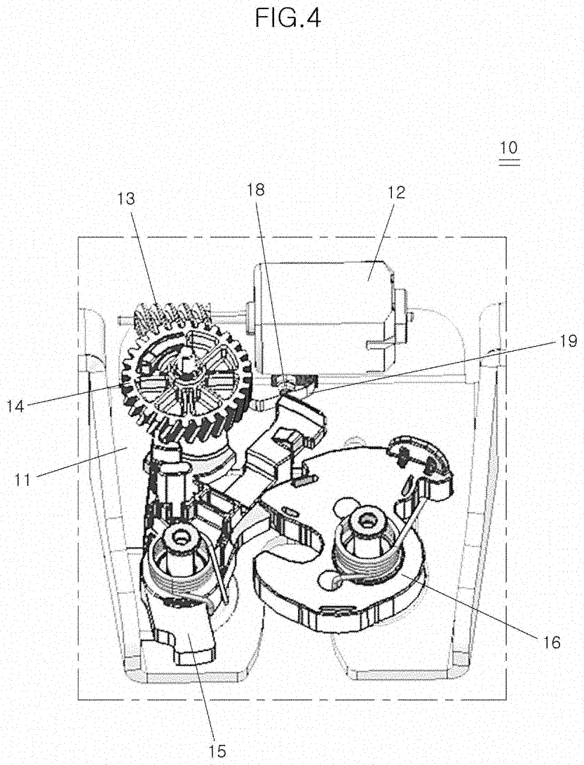

FIG. 5 is a front view showing a state in which a wheel gear starts to rotate in a tailgate latch assembly for a vehicle with improved detection performance according to an embodiment of the present disclosure;

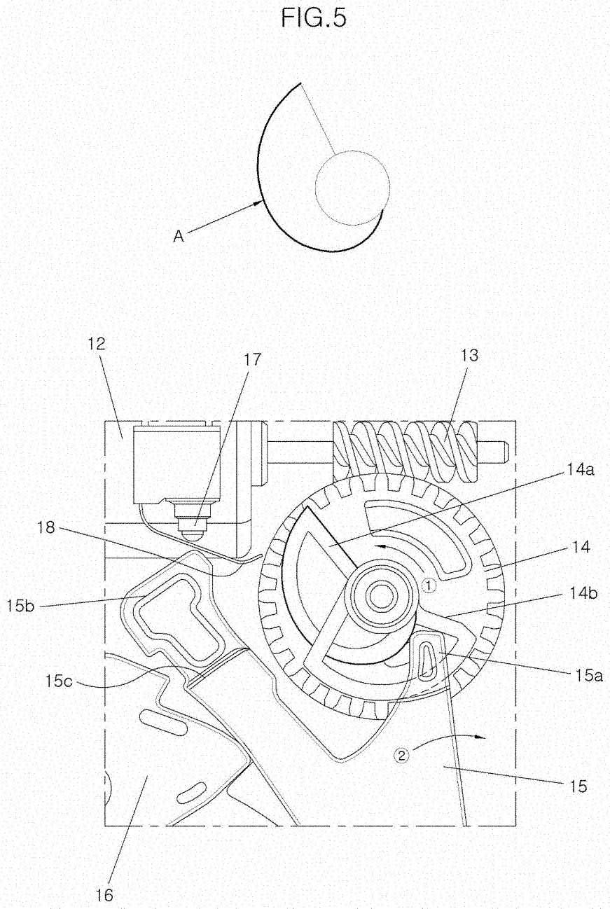

FIG. 6 is an enlarged view of the main part for showing the contact relationship between a wheel gear and a pawl, as shown in FIG. 5;

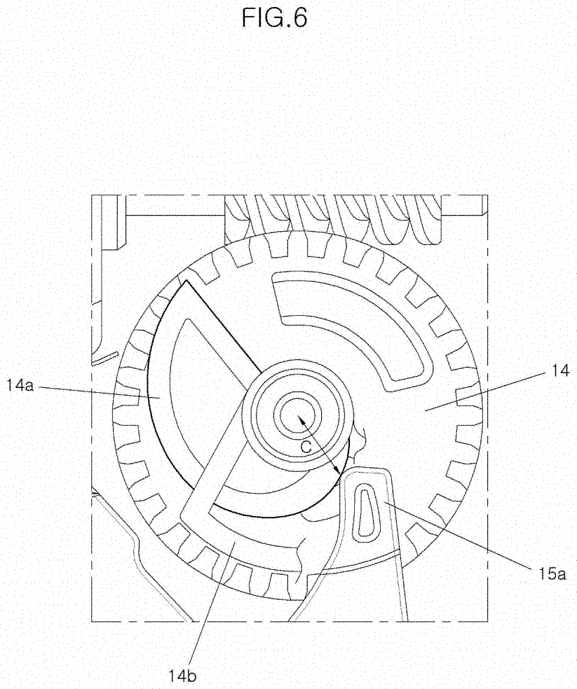

FIG. 7a is a graph showing rotational force of a wheel gear for rotating a pawl in a tailgate latch assembly for a vehicle with improved detection performance according to an embodiment of the present disclosure;

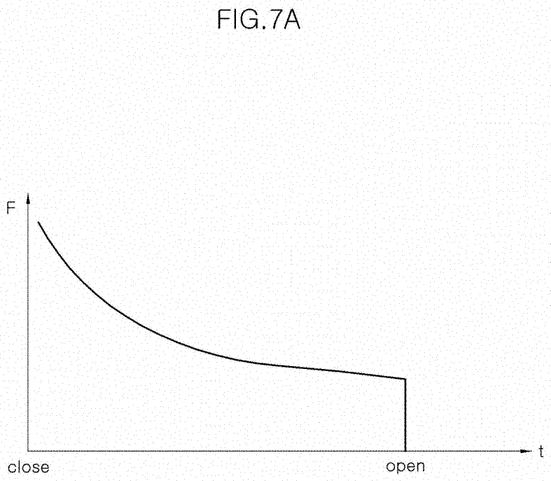

FIG. 7b is a graph showing rotational speed of a pawl at the time when a wheel gear rotating the pawl in a tailgate latch assembly for a vehicle with improved detection performance according to an embodiment of the present disclosure;

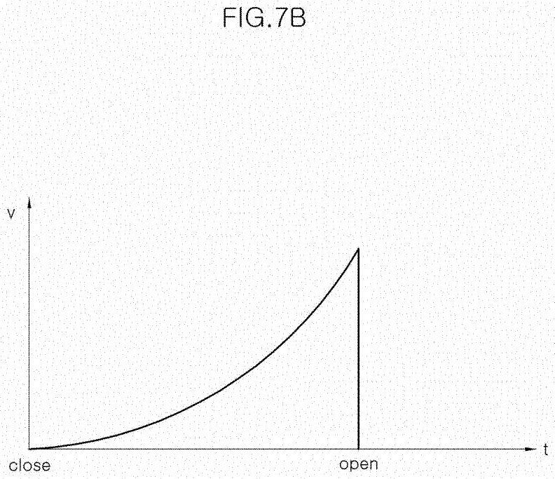

FIG. 8 is an enlarged view of the main part for showing an installation state of a switch for detecting rotation of a pawl in a tailgate latch assembly for a vehicle with improved detection performance according to an embodiment of the present disclosure; and

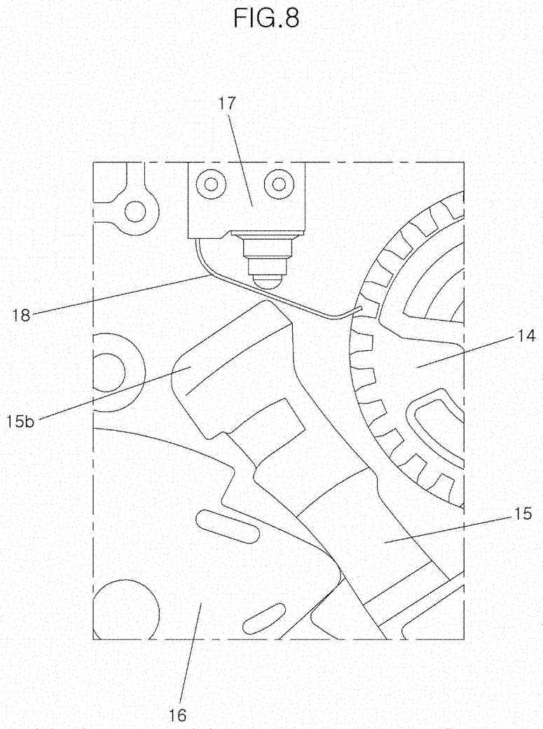

FIG. 9 is a plane view showing a state in which a pawl is rotated to release restraint of a claw in a tailgate latch assembly for a vehicle with improved detection performance according to an embodiment of the present disclosure.

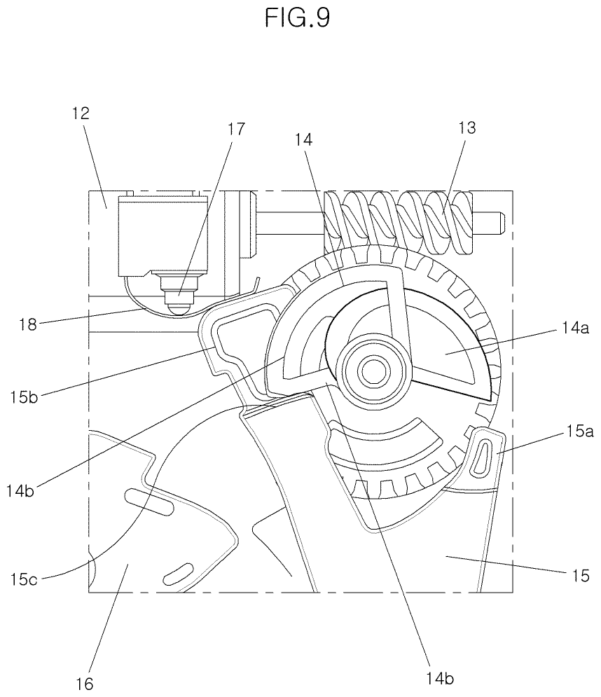

### DETAILED DESCRIPTION OF ILLUSTRATIVE EMBODIMENTS

Hereinafter, a tailgate latch assembly for a vehicle with improved detection performance according to an embodiment of the present disclosure will be described in detail with reference to the accompanying drawings.

A tailgate latch assembly for a vehicle with improved detection performance according to an embodiment of the present disclosure comprises a claw 16 which is supported resiliently in a direction of releasing restraint of the striker in a housing 11 and rotated in a direction opposite to the direction of being supported resiliently when the striker enters; a pawl 15 which is supported resiliently in the housing 11 and restrains or releases the claw 16; and a wheel gear 14 which is rotated by a drive motor 12 and releases restraint of the claw 16 by rotating the pawl 15 after pushing a contact part 15a formed on one side of the pawl 15 by an operation part 14a formed on one side of the wheel gear wherein an outer side face of the operation part 14a is formed in such a manner that distance from the center of the wheel gear 14 to a contact point of the operation part 14a varies as the wheel gear 14 rotates.

The housing 11 forms an external shape of the tailgate latch assembly 10 according to the embodiment of the present disclosure and allows other components which will be described later to be mounted thereto. One side of the housing 11 is formed in an incised state in order to allow a striker (not shown) to enter and exit the housing.

The drive motor 12 is driven when electric power is applied thereto whereby the tailgate latch assembly 10 can release the striker.

A worm wheel 13 is coupled to a rotating shaft of the drive motor 12 and the worm wheel 13 is meshed with a wheel gear 14. Rotational force of the drive motor 12 is transmitted to a pawl 15 which will be described later through the worm wheel 13 and the wheel gear 14.

The housing 11 is provided with the claw 16 for restraining the striker and the pawl 15 for restraining the claw 16, respectively. The pawl 15 and the claw 16 are resiliently supported by springs so as to rotate in a predetermined direction, respectively. In other words, the claw 16 is resiliently supported to rotate in a direction of releasing the striker, while the pawl 15 is resiliently supported to rotate in a direction of restraining the claw 16.

Basic shapes and functions of the pawl 15 and the claw 16 are the same as those in the conventional tailgate latch assembly and therefore will not be described herein.

The pawl 15 releases restraint of the claw 16 by the wheel gear 14 to be rotated by the drive motor 12. To this end, an operation part 14a for pushing and rotating the pawl 15 is formed on a side face of the wheel gear 14. A surface of the operation part 14a comes into contact with a contact part 15a formed on one side of the pawl 15. At this time, the wheel gear 14 is rotated while the operation part 14a and the contact part 15a are in contact with each other whereby the pawl 15 is pushed and rotated.

The operation part 14a is formed only in a partial section of the wheel gear 14. The operation part 14a is formed only in a section where the wheel 13 is forced to rotate by the wheel gear 14, but not in the remaining section. For example, the operation part 14a is formed in a section ranging approximately 180 degree.

The operation part 14a is formed in such a manner that distance c between the center of the wheel gear 14 and a contact point at which the operation part 14a and the contact part 15a are in contact with each other varies as the wheel gear 14 rotates.

Preferably, the operation part is formed in such a manner that the distance c between the center of the wheel gear 14 and the contact point at which the operation part 14a and the contact part 15a are in contact with each other increases as the wheel gear 14 rotates.

More preferably, the operation part is formed in such a manner that an increase rate of the distance c between the center of the wheel gear 14 and the contact point at which the operation part 14a and the contact part 15a are in contact with each other decreases as the wheel gear 14 rotates. Accordingly, in the section where the operation part 14a is formed, although the distance between the center of the wheel gear 14 and the contact point at which the operation part 14a and the contact part 15a are in contact with each other increases as the wheel gear 14 rotates, an increase rate, that is, an increase rate of the distance c decreases as the wheel gear 14 further rotates.

To this end, the outer side face of the operation part 14a is formed into an involute curve A with respect to the center of the wheel gear 14.

Since the outer side face of the operation part 14a where the operation part 14a is in contact with the contact part 15a is formed into the involute curve, the distance between the center of the wheel gear 14 and the contact point at which the operation part 14a and the contact part 15a are in contact with each other increases but the increase rate of the distance decreases as the wheel gear 14 rotates.

As described above, since the outer face of the operation part 14a is formed into the involute curve A, even if the wheel gear 14 rotates at a constant speed, the wheel gear 14 rotates the pawls 15 with high actuation force F in the beginning of contact between the operation part 14a and the contact part 15a and the distance c between the center of the wheel gear 14 and the contact point at which the operation part 14a and the contact part 15a are in contact with each other increases rapidly whereby the pawl 15 is rotated quickly with high release force. As a result, actuation of the pawl 15 to release the claw 16 is performed quickly and at the same time reliability is also improved. In addition, moving speed v of the pawl 15 increases as it goes to the latter period of the contact and thus, the time point at which actuation of releasing the claw 16 is completed is made earlier.

The wheel gear 14 is formed with a stopper 14b while the pawl 15 is formed with a catching ledge 15c such that the wheel gear 14 and the pawl 15 are restrained each other and thus no longer rotated when release of the claw 16 is completed by rotation of the wheel gear 14.

The stopper 14b is formed on one side face of the wheel gear 14, for example, a face of the wheel gear 14, on which the operation part 14a is formed, at a distance from the surface of the wheel gear 14 that is different from the distance at which the operation part 14a is formed. In other words, since the operation part 14a is formed adjacent to the surface of the wheel gear 14 whereas the stopper 14b is formed on the top portion of the operation part 14a, the operation part 14a and the stopper 14b are formed on different surfaces respectively.

The catching ledge 15c is formed in the shape of a single-stepped ledge along the radial direction of the pawl 15.

With the configuration as mentioned above, when the wheel gear 14 rotates at a predetermined angle and then the distance from the center of the wheel gear 14 to the contact point of the operation part 14a becomes a maximum, the stopper 14b is caught by the catching ledge 15c whereby the wheel gear 14 can no longer rotate and in turn the wheel gear 14 and the pawl 15 are kept stationary.

A switch 17 for detecting separation of the pawl 15 from the claw 16 is installed at one side of the housing 11 and the housing 11 is provided with a detection plate 18 for operating the switch 17 at the time when the pawl 15 is separated from the claw 16. The detection plate 18 is made of a metal material so that when the pawl 15 is separated from the claw 16, the pawl is deformed and in turn depresses the switch 17 to allow the switch to detect separation of the pawl 15 from the claw 16.

Since the switch 17 is operated by the detection plate 18 fixed to and extended from one side of the switch 17, the pawl 15 starts to come into contact with the detection plate 18 from the moment when the pawl 15 releases the claw 16 at one stage (in other words, the claw is half locked) and at the same time the detection plate 18 operates the switch 17 so that actuating range of the pawl 15 is detected from the moment when the pawl 15 releases the claw 16 at one stage to the moment when the pawl 15 completely releases the claw 16. The switch 17 detects actuation amount of the detection plate 18 as the pawl 15 operates the detection plate 18, and in turn detects a position of the pawl 15. As a result, the claw 16 is not rotated after the claw 16 is released at one stage so that it is possible to solve the problem that the position of the pawl 15 cannot be detected.

Although the present disclosure has been described in the foregoing with reference to the drawings illustrated by way of example, the present disclosure is not limited to the disclosed embodiments, and it will be apparent to those of ordinary skill in the art that various modifications and variations can be made to the present disclosure without departing from the spirit and scope of the disclosure. Therefore, such modifications or variations fall within the scope of the present disclosure as claimed and the scope of the present disclosure should be interpreted based on the appended claims.

What is claimed is:

1. A tailgate latch assembly for a vehicle, wherein the tailgate latch assembly is configured to restrain a striker formed in a tailgate which is opened or closed rearward of a vehicle or to release restraint of the striker, the tailgate latch assembly comprising:
a claw supported resiliently in a direction of releasing restraint of the striker in a housing and rotatable in a direction opposite to the direction of being supported resiliently when the striker enters;
a pawl supported resiliently in the housing and configured to restrain or release the claw; and
a wheel gear which is rotatable by a drive motor and configured to release restraint of the claw by rotating the pawl after pushing a contact part formed on one side of the pawl by an operation part formed on one side of the wheel gear, wherein an outer side face of the operation part is formed in such a manner that distance from the center of the wheel gear to a contact point of the operation part varies as the wheel gear rotates.

2. The tailgate latch assembly according to claim 1, wherein the outer side face of the operation part is formed in such a manner that the distance from the center of the wheel gear to the contact point of the operation part increases as the wheel gear further rotates.

3. The tailgate latch assembly according to claim 2, wherein the outer side face of the operation part is formed in such a manner that an increase rate of the distance from the center of the wheel gear to the contact point of the operation part decreases as the wheel gear further rotates.

4. The tailgate latch assembly according to claim 1, wherein the outer side face of the operation part is formed into an involute curve with respect to the center of the wheel gear.

5. The tailgate latch assembly according to claim 1, wherein the operation part is formed only in a partial section of the wheel gear.

6. The tailgate latch assembly according to claim 5, wherein one side face of the wheel gear is formed with a stopper for stopping rotation of the pawl at a time when the pawl is separated from the claw and a bottom face of the pawl is formed with a catching ledge to be caught by the stopper.

7. The tailgate latch assembly according to claim 6, wherein, when the pawl is separated from the claw, the catching ledge is caught by the stopper so that rotation of the pawl is stopped.

8. The tailgate latch assembly according to claim 7, wherein the catching ledge is formed to be caught by the stopper when the distance from the center of the wheel gear to the contact point of the operation part becomes a maximum.

9. The tailgate latch assembly according to claim 6, wherein the operation part and the stopper are formed at different distances from a surface of the wheel gear on one side face of the wheel gear.

10. The tailgate latch assembly according to claim 1, wherein a switch for detecting separation of the pawl from the claw is installed and wherein the tailgate latch assembly further comprises a detection plate for operating the switch at a time when the pawl is separated from the claw.

11. The tailgate latch assembly according to claim 10, wherein the detection plate is configured to be operated by an end of the pawl.

12. A vehicle comprising;
a vehicle body;
a tailgate hinged to the vehicle body and configured to be opened or closed rearward of a vehicle, the tailgate including a striker;
a tailgate latch assembly configured to restrain the striker or to release restraint of the striker, wherein the tailgate latch assembly comprises:
a claw supported resiliently in a direction of releasing restraint of the striker in a housing and rotatable in a direction opposite to the direction of being supported resiliently when the striker enters;
a pawl supported resiliently in the housing and configured to restrain or release the claw; and
a wheel gear which is rotatable by a drive motor and configured to release restraint of the claw by rotating the pawl after pushing a contact part formed on one side of the pawl by an operation part formed on one side of the wheel gear, wherein an outer side face of the operation part is formed in such a manner that distance from the center of the wheel gear to a contact point of the operation part varies as the wheel gear rotates.

13. The vehicle according to claim 12, wherein the outer side face of the operation part is formed in such a manner that the distance from the center of the wheel gear to the contact point of the operation part increases as the wheel gear further rotates.

14. The vehicle according to claim 13, wherein the outer side face of the operation part is formed in such a manner that an increase rate of the distance from the center of the wheel gear to the contact point of the operation part decreases as the wheel gear further rotates.

15. The vehicle according to claim 14, wherein one side face of the wheel gear is formed with a stopper for stopping rotation of the pawl at a time when the pawl is separated from the claw and a bottom face of the pawl is formed with a catching ledge to be caught by the stopper.

16. The vehicle according to claim 15, wherein the operation part and the stopper are formed at different distances from a surface of the wheel gear on one side face of the wheel gear.

17. The vehicle according to claim 12, wherein the outer side face of the operation part is formed into an involute curve with respect to the center of the wheel gear.

18. The vehicle according to claim 12, wherein a switch for detecting separation of the pawl from the claw is installed and wherein the tailgate latch assembly further comprises a detection plate for operating the switch at a time when the pawl is separated from the claw.

19. The vehicle according to claim 18, wherein the detection plate is configured to be operated by an end of the pawl.
